(19) United States
(12) Patent Application Publication
(10) Pub. No.: US 2018/0095604 A1
(43) Pub. Date: Apr. 5, 2018

(54) RENDERING COMPONENTS BASED ON SCREEN SIZE

(71) Applicant: Microsoft Technology Licensing, LLC, Redmond, WA (US)

(72) Inventors: Tuan Anh Nguyen, Bellevue, WA (US); Karl Derek Hellstern, Kirkland, WA (US)

(21) Appl. No.: 15/283,139

(22) Filed: Sep. 30, 2016

(51) Int. Cl. G06F 3/0481; G06F 17/22

(52) U.S. Cl. CPC G06F 3/0481; G06F 17/248; G06F 17/2288

(57) ABSTRACT

Rendering user interface components based on screen size. A plurality of user interface components are first defined. Each particular user interface component definition is associated with a uniform resource identifier, and has a screen size indication identifying at least one screen size that can display the particular user interface component. User input is then received from a user device having a screen size. The received user input is associated with navigating to a uniform resource identifier. The navigated uniform resource identifier may then be determined to be associated with a particular user interface component definition. A determination is then made that the screen size of the user device is included within the at least one screen size identified in the screen size indication of the particular user interface component definition. The particular user interface definition is then used to display the corresponding defined user interface component.

### BACKGROUND

Computer systems and related technology affect many aspects of society. Indeed, the computer system's ability to process information has transformed modern society. Computer systems now commonly perform a host of tasks (e.g., word processing, scheduling, accounting, etc.) that prior to the advent of the computer system were performed manually. Computer systems are often coupled to one another and to other electronic devices to form both wired and wireless computer networks. Such networks allow for transferring electronic data to and from computer systems and other electronic devices.

More recently, computer systems and devices have been developed in all shapes and sizes. For example, mobile computer devices may have screens that are smaller than four inches, while desktop monitors may be more than 50 inches. With the advent of mobile devices, such as phones, tablets, and watches, software applications and websites now must be developed as being both mobile and desktop friendly. As such, user interfaces associated with software applications and websites are often created to function with the smallest mobile devices, as well as the largest desktop screens. Accordingly, it can often be difficult to create user interfaces that are compatible with both ends of the screen size spectrum.

### BRIEF SUMMARY

At least some embodiments described herein relate to rendering user interface components based on screen size. For example, embodiments may include defining a plurality of user interface components, wherein each particular user interface component definition is associated with a uniform resource identifier. Each particular user interface component definition also has a screen size indication identifying at least one screen size for screens that can display the particular user interface component. User input is then received from a user device that has a particular screen size. The received user input is associated with navigating to a particular uniform resource identifier.

The navigated uniform resource identifier may then be determined to be associated with a particular user interface component definition of the plurality of user interface component definitions. A determination may also be made that the screen size of the user device is included within the at least one screen size identified in the screen size indication of the particular user interface component definition. The particular user interface definition is then used to display the corresponding defined user interface component of the plurality of user interface components.

As such, a declarative HTML template may be used to ensure that UI components, although implemented independently, are properly rendered in relation to each other on the same page of a web application, website, webpage, or web service, regardless of the size of the screen being used to display the UI components. Additionally, the HTML template may be used to deep-link to a particular UI component within a particular page, as well as to render any UI components associated with the deep-linked component based on screen size. Finally, the HTML template may perform these functions without creating custom logic/code for every possible screen size.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture for performing the principles described herein.

FIG. 2 illustrates a user interface environment when rendering UI components within a medium-sized or large-sized screen.

FIG. 3 illustrates a user interface environment when rendering UI components within a small-sized screen.

FIG. 4 illustrates a user interface environment when rendering UI components within an extra small-sized screen.

FIG. 5 illustrates a second user interface environment when rendering UI components within an extra small-sized screen.

FIG. 6 illustrates a flow chart of an example method for using an HTML template to render UI components based on screen size.

### DETAILED DESCRIPTION

At least some embodiments described herein relate to rendering user interface components based on screen size. For example, embodiments may include defining a plurality of user interface components, wherein each particular user interface component definition is associated with a uniform resource identifier. Each particular user interface component definition also has a screen size indication identifying at least one screen size for screens that can display the particular user interface component. User input is then received from a user device that has a particular screen size. The received user input is associated with navigating to a particular uniform resource identifier.

The navigated uniform resource identifier may then be determined to be associated with a particular user interface component definition of the plurality of user interface component definitions. A determination may also be made that the screen size of the user device is included within the at least one screen size identified in the screen size indication of the particular user interface component definition. The particular user interface definition is then used to display the corresponding defined user interface component of the plurality of user interface components.

As such, a declarative HTML template may be used to ensure that UI components, although implemented independently, are properly rendered in relation to each other on the same page of a web application, website, webpage, or web service, regardless of the size of the screen being used to display the UI components. Additionally, the HTML template may be used to deep-link to a particular UI component within a particular page, as well as to render any UI components associated with the deep-linked component based on screen size. Finally, the HTML template may perform these functions without creating custom logic/code for every possible screen size.

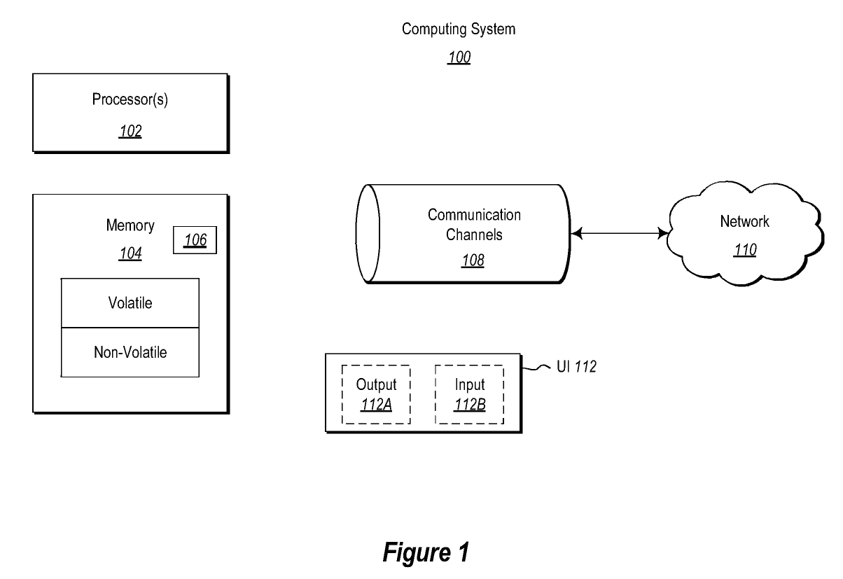

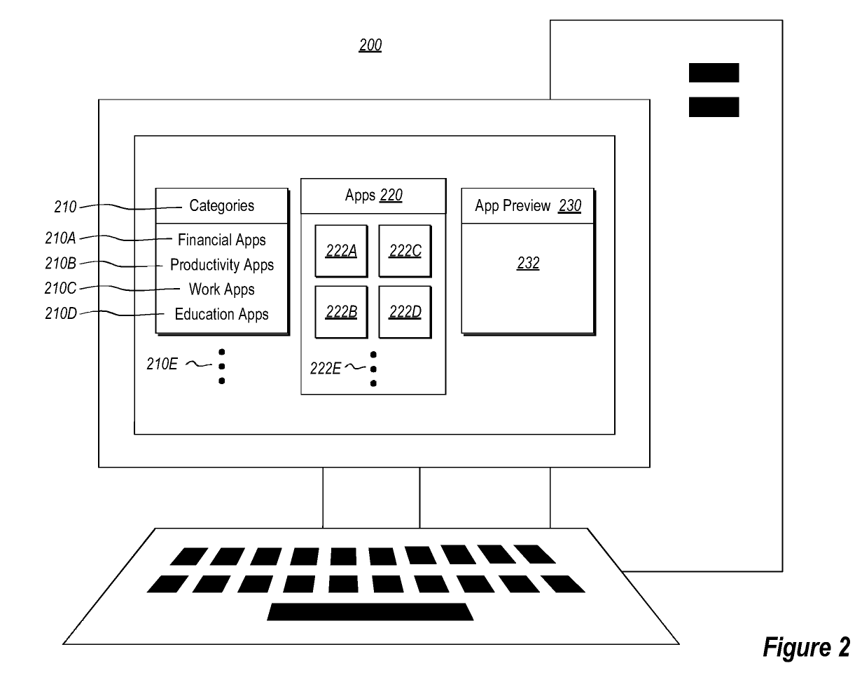

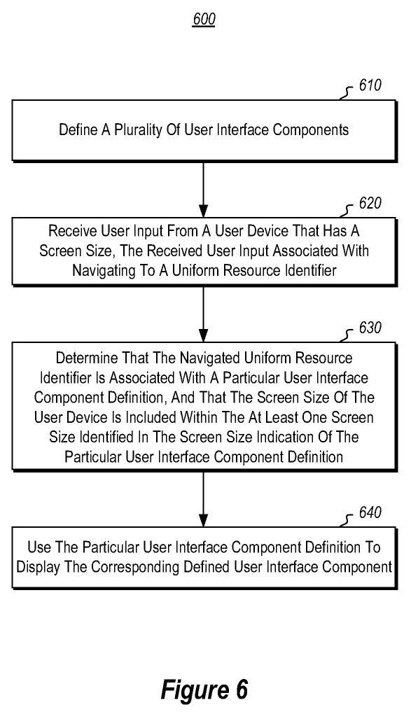

Some introductory discussion of a computing system will be described with respect to FIG. 1. Then, environments illustrating the rendering of UI components on different sized screens will be described with respect to FIGS. 2 through 5. Finally, an example method for using a declarative HTML template to render UI components based on screen size will be described with respect to FIG. 6.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “control” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

FIGS. 2 through 5 each illustrate a user interface (UI) environment having UI components/controls (component/control is used interchangeably throughout) tailored to a particular screen size. In combination, FIGS. 2 through 5 illustrate the possible differences in type and positioning of UI components of the same particular web page or particular page of an application when navigated to using different screen sizes. As such, each of the UI environments illustrated include a different number, different type, or different positioning of UI components based on the screen size used. Furthermore, each of the components included within each of the user interface environments may be individually identified, such that a user can deep-link to any single component within the particular user interface environment, as described more fully herein. While there are a particular number and type of UI components illustrated in FIGS. 2 through 5, the principles described herein may be applicable regardless of the number, type, or appearance of UI components. In some embodiments, the principles described herein may be applied within the context of a web version of an application or any particular website having one or more UI components.

FIG. 2 illustrates an exemplary user interface (UI) environment 200 when a user of the UI is currently using a device having a medium-sized or large-sized screen, as described more fully herein. The UI environment 200 may include, for instance, a UI that is displayed on the display 112 of FIG. 1. The environment 200 includes three UI components, including category selection portion 210, app thumbnail portion 220, and app preview portion 230. Category selection portion 210 may comprise a list of app categories that an end user has created, or to which an end user has access. As shown, category selection portion 210 includes four different categories of apps, including financial apps 210A, productivity apps 210B, work apps 210C, and education apps 210D. Ellipses 210E represents that while only four different categories of apps are shown, there may be any number or type of apps. Selection of one of the app categories may result in each app of a particular category being displayed in app thumbnail portion 220. For example, selection of the financial apps category 210A may result in any number of associated financial app thumbnails 222 to which a user has access.

As illustrated, app thumbnails portion 220 includes four app thumbnails (apps 222A through 222D—referred to collectively as apps 222). While only four app thumbnails 222 are shown, ellipses 222E represents that there may be any number of app thumbnails. Selection of one of the app thumbnails 222 may result in a preview of the particular selected app within the app preview portion 230. App preview portion 230 may include a display portion 232, in which a preview of any particular app associated with a selected app thumbnail 222 may be displayed. In the ongoing example, each of the app thumbnails 222 may relate to a particular financial app. Accordingly, when one of the financial app thumbnails have been selected, a preview of the particular app associated with the selected app thumbnail may be displayed within the display portion 232 of app preview portion 230.

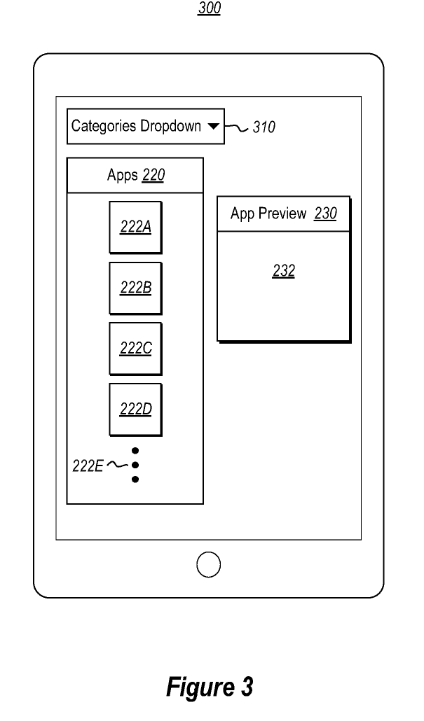

As discussed briefly, the principles described herein may be applied within the context of a web version of an application or any particular website having one or more UI components. For example, UI environment 200 (as well as the environments in FIGS. 3 through 5) may be a particular web page of a web version of MICROSOFT POWERAPPS™. As such, app categories portion 210 may include one or more app categories relating to apps that a user has created, or to which the user has access, within MICROSOFT POWERAPPS. Similarly, app thumbnails portion 220 may include thumbnail representations of each of those apps of a particular selected category 210 to which the user has access. Likewise, app preview 230 may display a preview of any app associated with a selected app thumbnail 222.

FIG. 3 illustrates another exemplary user interface (UI) environment 300 when a user of the UI is currently using a device having a small-sized screen, as described more fully herein. The UI environment 300 may include, for instance, a UI that is displayed on the display 112 of FIG. 1. The environment 300 includes similar UI components to that of environment 200 in FIG. 2. As illustrated, environment 300 has two of the same UI components as environment 200, which are app thumbnail portion 220 and app preview portion 230.

The third component, app categories dropdown 310, may perform essentially the same function as app categories portion 210 of FIG. 2, while being tailored to a small screen. When selected, app categories dropdown 310 may show all of the same app categories as the app categories portion 210. However, until being selected, the app categories dropdown 310 may be closed, thus limiting the amount of screen space the app categories dropdown uses. Also, as illustrated in FIG. 3, app thumbnails portion 220 may be displayed in one vertical column of thumbnails rather than utilizing two columns, as shown in FIG. 2. Other than this difference in display of the thumbnails, the functionality of the thumbnails may be identical to the functionality described with respect to FIG. 2. Additionally, the display and functionality of the app preview portion 230 may be identical to the description of the app preview portion 230 with respect to FIG. 2.

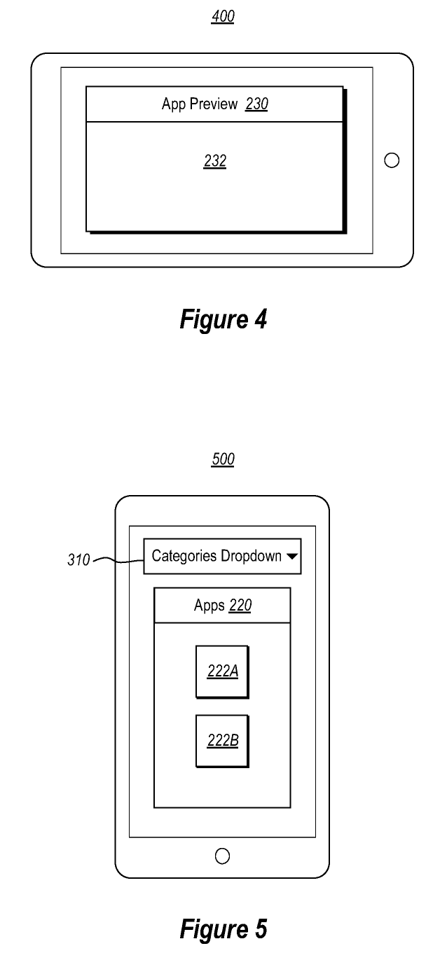

FIGS. 4 and 5 illustrate exemplary user interface environment 400 and user interface environment 500 when a user of the UI is currently using a device having an extra small-sized screen, as described more fully herein. The UI environment 400 and the UI environment 500 may also include a UI that is displayed on the display 112 of FIG. 1. The environment 400 only includes one user interface component, the same app preview portion 230 as environment 200 and environment 300 (of FIGS. 2 and 3, respectively). On the other hand, environment 500 includes the same app categories dropdown 310 and the same one vertical column app thumbnails portion 220 as FIG. 3.

Oftentimes UI components, such as those described with respect to FIGS. 2 through 5, are implemented independently, yet need to be rendered in relation to each other on the same page. Additionally, as illustrated in FIGS. 2 through 5, screen size may be critical to the interplay between UI components regarding how/where they are displayed on the same page. For example, the same web page may need to display a first set of UI components when the screen is a first size and a second set of UI components when the screen is a second size.

In a more specific example, FIG. 2 illustrates three UI components and how they may be displayed with respect to a medium-sized or large-sized screen. Comparing FIG. 2 to FIG. 3 shows that using a small-sized screen to navigate to the same page (as FIG. 2) may result in a different combination of displayed UI components. As illustrated in FIG. 3, two of the same three UI components as FIG. 2 are displayed, along with a smaller third UI component. As described previously, each of the UI components may also be deep-linkable. Furthermore, when a user deep-links to a particular UI component that is presented in a set of UI components, all components in the same set are then to be displayed. For example, if a user deep-links to the app preview portion 230 in FIG. 2, both app categories portion 210 and app thumbnails category 220 are also to be displayed.

Generally, it would be necessary to write custom UI logic for each individual screen size or breakpoint in order to address all of these concerns. However, all of these issues may be resolved without writing custom UI logic for each screen size by employing a declarative syntax in the form of a hypertext markup language (HTML) template that creates and configures logical groupings of UI components. Such an HTML template may involve extending HTML with two new tags. The first tag may specify a routing template that can be used to determine when a particular control is being deep-linked. As such, when a UI control's routing template matches with a uniform resource identifier (URI), or uniform resource locator (URL), to which a user is navigating, the UI control becomes visible to the user. Additionally, deep-linking to any one of the UI controls activates the visibility of a logical group to which it belongs. As such, the second tag may define a logical grouping, as well as which logical group of controls should be visible by default for each of a number of different responsive breakpoints (e.g., screen sizes). For example, suppose that a user that is currently using a device having a large-sized screen, deep-links to a particular UI component that is to be displayed on large screens. In such a case, all other UI components that are to be displayed on large-sized screens will also be displayed on the user's screen.

The number of different responsive breakpoints may include defining breakpoints associated with different screen sizes. For instance, four different breakpoints/screen sizes may be defined, including extra small (xs), small (sm), medium (md), and large (lg). These individual screen sizes may be defined as being any size. For example, the extra small screen may be any screen that is less than four inches, the small screen may be any screen that is between four and six inches, the medium screen may be any screen that is between six inches and eleven inches, and the large screen may be any screen bigger than eleven inches. However, these sizes are only examples, as these breakpoints/screen sizes may be defined as being any appropriate size and may be easily re-defined. Likewise, while four breakpoints/screen sizes are included in the previous example, there may be any number of breakpoints/screen sizes defined. Furthermore, any defined breakpoints may be configured to match with breakpoints implemented by frameworks that are already in use to style websites (e.g., popular cascading style sheets frameworks).

An example of a first portion of such an HTML template, as described herein, may include the following:

```
<pa-control id=“categories-dropdown”
  control-id=“/:galleryName”
  groups=“sm-smGroup xs-thumbnailsDropdownGroup”>
</pa-control>
```

As shown, the first portion defines a particular control called the “categories-dropdown” control. The categories-dropdown control may be the same app categories dropdown component 310 that was discussed in both FIGS. 3 and 5. The first portion also includes a first tag that defines a routing template of “/:galleryName”. As previously described, the routing template may be used to determine when a UI control is being deep-linked. For example, a user may navigate directly to the categories-dropdown UI control when the user navigates to a URL that includes “/:galleryName”. The first portion of the HTML template also includes a second tag that defines two logical groupings of “sm-smGroup” and “xs-thumbnailsDropdownGroup”. The smGroup is a logical grouping that includes any detected small screen sizes, while the thumbnailsDropdownGroup is a logical grouping that includes any detected extra small screens.

A second portion of the HTML template relating to a separate categories control may include the following:

```
<pa-control id=“categories”
  control-id=“/:galleryName”
  groups=“lg:md-lgMdGroup”>
</pa-control>
```

As shown, the second portion defines a particular control called the “categories” control. The categories control may be the same app categories portion 210 that was discussed in relation to FIG. 2. The second portion also includes the same first tag, or routing template as the first portion, “/:galleryName” As such, if a user navigates to a URL that includes the routing template “/:galleryName”, both the logical groupings (i.e., the screen sizes) included in the first tag of the first and second portions and a screen size of the user must be identified in order to determine to which control the user is to be deep-linked. For instance, if it is determined that a user has navigated to a URL that matches the “/:galleryName” routing template, and is currently using a device with a small or extra small screen, the user will be deep-linked to the categories-dropdown control. On the other hand, if it is determined that the user is currently using a device with a medium or large screen, the user will be deep-linked to the categories control.

An example of a third and fourth portion of the HTML template, each relating to a different control, may include the following:

```
<pa-control id=“thumbnails”
  control-id=“/:galleryName/:categoryId”
  groups=“lg:md-lgMdGroup sm-smGroup
  xs-thumbnailsDropdownGroup”>
</pa-control>
<pa-control id=“preview”
  control-id=“/:galleryName/:categoryId/:itemId”
  groups=“lg:md-lgMdGroup sm-smGroup xs-previewOnlyGroup”>
</pa-control>
```

As shown, the third portion defines a thumbnails control, while the fourth portion defines a preview control. Once again, these controls may be similar to the controls illustrated in FIGS. 2 through 5. For instance, the thumbnails control may be the same control as the apps thumbnails portion 220, while the preview control may be the same control as the app preview portion 230. Additionally, the third and fourth portions may include a first tag that defines a routing template of “/:galleryName/:categoryId” and “/:galleryName/:categoryId/:itemId”, respectively. Once again, while only four controls are defined within the HTML template shown above, there may be any number of defined controls, having any number of breakpoints or screen sizes. Additionally, as shown, larger screen sizes may be associated with more user interface components (or user interface component definitions) than smaller screen sizes, such that when a screen size of a user is larger, more user interface components will be displayed.

FIG. 6 illustrates a flow chart of an example method 600 for using the previously described HTML template to render the appropriate user interface components based on screen size. Method 600 will be described with frequent reference to the environments of FIGS. 2 through 5, as well as to the HTML code described above. The method 600 includes defining a plurality of user interface components (Act 610). For example, user interface components may include category selection portion 210, app thumbnails portion 222, app preview portion 230, app categories dropdown 310, and so forth. Each particular user interface component definition may be associated with a uniform resource identifier. Additionally, each particular user interface component definition may have a screen size indication that identifies at least one screen size that is associated screens having a particular screen size that is capable of displaying the particular user interface component. For instance, app categories dropdown 310 may have a routing tag/template of “/:galleryName” that is associated a URI having the same text. Additionally, app categories dropdown has a screen size indication that at identifies both a small screen size and an extra small screen size.

The method 600 further includes receiving user input from a user device that has a particular screen size, wherein the received user input is associated with navigating to a uniform resource identifier (Act 620). For example, a user may navigate to a URI that at least partially matches a routing tag of a particular user interface component using a web browser. Furthermore, that particular user may be currently using any one of a laptop, desktop, smart phone, tablet, and so forth, having a particular screen size when the navigation is performed.

The method 600 also includes determining that the navigated uniform resource identifier is associated with a particular user interface component definition of the plurality of user interface component definitions, and that the screen size of the user device is included within the at least one screen size identified in the screen size indication of the particular user interface component definition (Act 630). For instance, a determination may be made that at least a portion of a URI to which a user is navigating matches a routing tag of a particular user interface component definition. Furthermore, a determination may be made that a screen size of a device that the user is currently using has been identified as being associated with the same particular user interface component definition.

Once these determinations have been made, the particular user interface component definition may be used to display the corresponding defined user interface component of the plurality of user interface components (Act 640). As such, a particular user interface component corresponding to a user interface component definition that includes both the determined portion (e.g., a routing tag) of a URI to which the user is navigating, as well as the determined screen size of the user's device, the particular user interface component may be displayed on a screen of the user's device. Additionally, a determination may then be made as to whether any other user interface component definitions also include the user's screen size as a screen size capable of displaying the corresponding user interface component. If so, each of those other user interface component definitions may be used to display the corresponding user interface component(s). For instance, as shown in FIG. 2, the large screen size is associated with category selection portion 210, app thumbnails portion 222, and app preview portion 230. As such, when a user having a device with a large screen size navigates/deep-links to any one of those three user interface components, the other two user interface components may also be displayed.

In this way, a declarative HTML template may be used to ensure that UI components, although implemented independently, are properly rendered in relation to each on the same page of a web application, website, webpage, or web service, regardless of the size of the screen being used to display the UI components. Additionally, the HTML template may be used to deep-link to a particular UI component within a particular page, as well as to render any UI components associated with the deep-linked component based on screen size. Finally, the declarative HTML template may perform these functions without creating custom logic/code for every possible screen size.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system comprising:
one or more processors; and
one or more computer-readable storage media having stored thereon computer-executable instructions that are executable by the one or more processors to cause the computer system to render user interface components based on screen size, the computer-executable instructions including instructions that are executable to cause the computer system to perform at least the following:
define a plurality of user interface components, wherein each particular user interface component definition is associated with a uniform resource identifier, and has a screen size indication identifying at least one screen size for screens that can display the particular user interface component;
receive user input from a user device that has a screen size, the received user input associated with navigating to a uniform resource identifier;
determine that the navigated uniform resource identifier is associated with a particular user interface component definition of the plurality of user interface component definitions, and that the screen size of the user device is included within the at least one screen size identified in the screen size indication of the particular user interface component definition; and
use the particular user interface component definition to display the corresponding defined user interface component of the plurality of user interface components.

2. The computer system in accordance with claim 1, wherein the screen size of the user device is also included within the screen size indication of one or more user interface component definitions that are different than the particular user interface component definition.

3. The computer system in accordance with claim 2, wherein the one or more different user interface component definitions are also used to display the corresponding defined user interface components.

4. The computer system in accordance with claim 1, wherein each user interface component definition also includes a routing tag that corresponds to the associated uniform resource identifier.

5. The computer system in accordance with claim 4, wherein each routing tag allows for deep-linking to a corresponding user interface component.

6. The computer system in accordance with claim 1, wherein larger screen sizes are included within more screen size indications of the plurality of user interface component definitions than smaller screen sizes, such that when the screen size of the user is larger, more user interface components are displayed.

7. The computer system in accordance with claim 6, wherein a plurality of screen sizes are pre-defined.

8. The computer system in accordance with claim 1, wherein the pre-defined screen sizes include at least a large screen size, a medium screen size, a small screen size, and an extra small screen size.

9. A method, implemented at a computer system that includes one or more processors, for rendering one or more components based on screen size, comprising:
defining a plurality of user interface components, wherein each particular user interface component definition is associated with a uniform resource identifier, and has a screen size indication identifying at least one screen size for screens that can display the particular user interface component;
receiving user input from a user device that has a screen size, the received user input associated with navigating to a uniform resource identifier;
determining that the navigated uniform resource identifier is associated with a particular user interface component definition of the plurality of user interface component definitions, and that the screen size of the user device is included within the at least one screen size identified in the screen size indication of the particular user interface component definition; and
using the particular user interface component definition to display the corresponding defined user interface component of the plurality of user interface components.

10. The method in accordance with claim 9, wherein the screen size of the user device is also included within the screen size indication of one or more user interface component definitions that are different than the particular user interface component definition.

11. The method in accordance with claim 10, wherein the one or more different user interface component definitions are also used to display the corresponding defined user interface components.

12. The method in accordance with claim 9, wherein each user interface component definition also includes a routing tag that corresponds to the associated uniform resource identifier.

13. The method in accordance with claim 12, wherein each routing tag allows for deep-linking to a corresponding user interface component.

14. The method in accordance with claim 9, wherein larger screen sizes are included within more screen size indications of the plurality of user interface component definitions than smaller screen sizes, such that when the screen size of the user is larger, more user interface components are displayed.

15. The method in accordance with claim 14, wherein a plurality of screen sizes are pre-defined.

16. The method in accordance with claim 15, wherein the pre-defined screen sizes include at least a large screen size, a medium screen size, a small screen size, and an extra small screen size.

17. A computer program product comprising one or more hardware storage devices having stored thereon computer-executable instructions that are executable by one or more processors of a computer system to render one or more components based on screen size, the computer-executable instructions including instructions that are executable to cause the computer system to perform at least the following in response to:
define a plurality of user interface components, wherein each particular user interface component definition is associated with a uniform resource identifier, and has a screen size indication identifying at least one screen size for screens that can display the particular user interface component;
receive user input from a user device that has a screen size, the received user input associated with navigating to a uniform resource identifier;
determine that the navigated uniform resource identifier is associated with a particular user interface component definition of the plurality of user interface component definitions, and that the screen size of the user device is included within the at least one screen size identified in the screen size indication of the particular user interface component definition; and
use the particular user interface component definition to display the corresponding defined user interface component of the plurality of user interface components.

18. The computer program product in accordance with claim 17, wherein the screen size of the user device is also included within the screen size indication of one or more user interface component definitions that are different than the particular user interface component definition.

19. The computer program product in accordance with claim 18, wherein the one or more different user interface component definitions are also used to display the corresponding defined user interface components.

20. The computer program product in accordance with claim 17, wherein each user interface component definition also includes a routing tag that corresponds to the associated uniform resource identifier.
